(19) United States
(12) Patent Application Publication
(10) Pub. No.: US 2005/0178218 A1
(43) Pub. Date: Aug. 18, 2005

(54) Micro-volume blood sampling device

(76) Inventor: Jean Montagu, Brookline, MA (US)

Correspondence Address: LESLIE MEYER-LEON, ESQ.;IP LEGAL STRATEGIES GROUP P.C., 1480 FALMOUTH ROAD, P.O. BOX 1210, CENTERVILLE, MA, 02632-1210, US

(21) Appl. No.: 11/045,425

(22) Filed: Jan. 26, 2005

Related U.S. Application Data
(60) Provisional application No. 60/539,819, filed on Jan. 28, 2004.

(51) Int. Cl. G01N 1/10

(52) U.S. Cl. 73/864.34

(57) ABSTRACT

The invention features a single tool for collecting a known volume of a fluid biological sample from an animal, such as a human or small mammal, for mixing the sample with a predetermined amount of a reagent or a diluent, physically separate components of the sample, for storing the sample in a secure and stable fashion, and for then recovering some or all of the sample in a condition suitable for performing a diagnostic assay. The tool can be equipped with an optional means of recording or displaying information about the sample, such as a tag, a bar code, or a surface indicator that identifies, e.g., the date, animal number, and any additional information necessary. A second bar coded label to remove and attaché to the cage shall be provided. The cage/blood-sample can be correlated if needed at a later date.

### REFERENCE TO PRIOR APPLICATION

This application is based on and claims priority from U.S. Provisional Patent Application Ser. No. 60/539,819, filed Jan. 28, 2004, which is hereby incorporated by reference.

### FIELD OF THE INVENTION

This invention relates to a device and method for obtaining a sample of biological fluid.

### BACKGROUND OF THE INVENTION

The availability of increasingly sensitive biological assays has made it possible to run accurate diagnostic tests on biological samples of very small volume. Obtaining a small fluid sample from an individual, for example 100 microliters (μl) or less, can be a difficult task. Where the individual is a human patient, small volumes of blood are conventionally removed by finger puncture, the finger pricked with a lancet and then squeezed until a fluid drop of, e.g., 10-20 μl, is obtained. When collecting fluid samples from a small mammal, for example, a blood sample from a mouse or rat, the underside of the animal's tail is nicked with a sharp instrument such as a razor blade; the fluid is drawn into a small capillary tube, and then forced out into a collection tube using a rubber bulb or a piston. In most cases, further manipulations are required once the sample is obtained. The sample may be mixed with a stabilizing agent to permit storage of the sample at room temperature. Depending on the assay for which the sample is intended, it may also be necessary to add diluents and/or reagents, or it may be necessary to manipulate physically the sample, for example by centrifuging the sample as a means of separating components. Thus, current methods involve performing numerous steps, with the use of multiple pieces of equipment and disposable items. Various kits are available to supply these assorted items, such as Unopette® (Becton Dickinson and Company, East Rutherford, N.J.), Fisherbrand® microhematocrit and capillary tubes (Fisher Scientific Company, Hampton N.H.), and the StatSampler® capillary blood collection kit (StatSpin, Norwood, Mass.), but each of these kits rely on multiple separate components for performing the functions of sample collection, processing, and recovery.

### SUMMARY OF THE INVENTION

Applicants have designed a simple tool that is capable of performing the multiple tasks of collecting and manipulating a fluid biological sample within a single device, and then recovering a metered amount of the sample for further analysis, such as in a laboratory test for research or monitoring purposes, a screening test, or a diagnostic assay. The device can be used in conjunction with a fluid sample from any source, animate or inanimate. Preferably, the device is used to collect a fluid sample from an animal, e.g., a mammal, a human, a bird, or a reptile. The device further has the advantage of protecting the user from direct contact with the fluid sample, thereby minimizing transmission of infection, e.g., HIV or hepatitis C. In one embodiment, the device is used to draw a predetermined volume of blood from an animal, dilute it in a predetermined ratio, easily and rapidly separate components from the sample by centrifugal force, and permit a simple manual discharge of some or the entire sample in a measured manner. Optionally, the sample collection tool is further enhanced with features useful for identifying and tracking the specimens held and processed within the device, such as tags, bar codes, or surface properties bearing the date, source of specimen, and any other information useful to the handler.

Briefly, and in general terms, the sample collection device of the invention is used by contacting a drop of fluid sample with the conduit portion of the device, and allowing a known volume of sample to enter the conduit by capillary flow. The device is then placed in a centrifuge, e.g., by attaching to a centrifuge rotor or centrifuge platen, and subjected to centrifugal force. When centrifuged, the fluid sample is spun into a central chamber or space within the receptacle body portion 1 of the device. The strength of the centrifugal force can be chosen so that components of the sample are differentially spun into different cavities within the device. In that way, for example where the sample is whole blood, red cells separate and become trapped in a cavity of the device, usually in an aggregate or clotted state. The serum remains in the central chamber 12. Where the device is further equipped with a reservoir that holds dilution fluid or a fluid reagent, the centrifugal forces are also intended to force that fluid out of the reservoir cavity 14 and into the central chamber 12.

The processed sample is finally recovered from the device by manual expulsion of the fluid back through the conduit. The device is turned vertically to allow a portion of the liquid in the central chamber to enter into a vent plug, causing the plug to swell and permitting the finger pump to be actuated. A preset volume of fluid is then forced back out of the device through the conduit by pressing and deforming the cover 50 of the receptacle body in a controlled manner. The dimensions of the chamber 12 and the permitted free travel of the cover 50 are pre-chosen so that full pressure on the cover 50 pushes out a metered volume of fluid. Relieving pressure on the cover permits the cover to resume its original position, pulling the fluid in the conduit and air back into the central chamber 12. As the cover 50 is released, the device sucks in the fluid within conduit 20 and air. Only the fluid within the conduit 20 is desired to be retained, so care should be taken to avoid aspiring any fluid back into the device beyond the content of the conduit 20. Repeating the action permits multiple metering of the volume exhausted.

Accordingly, the invention features a sample collection device that includes a conduit portion and a receptacle body portion in fluid communication with the conduit portion, the conduit portion having a volume of less than 200 microliters, and the receptacle body portion including, affixed to the receptacle body portion, means for allowing a fluid sample to enter the receptacle portion via the conduit portion, and means for forcing the fluid sample to exit the receptacle portion via the conduit portion. The sample collection device can further include means for attaching the device to a centrifuge, such as, without limitation, a centrifuge platen. The receptacle body portion can further include a fluid reservoir, a resident fluid within the fluid reservoir, and means for allowing the resident fluid to mix with the fluid sample. In another embodiment, the receptacle body portion further includes a means for sequestering a separable component from the fluid sample.

Preferably, the receptacle body portion includes an interior space having an interior pressure, and further includes a means for maintaining the interior pressure at atmospheric pressure. The receptacle body can further include means for increasing and decreasing the interior pressure within the device, and/or means for maintaining the interior pressure at atmospheric pressure. Where the fluid sample has a vapor phase, the receptacle body portion can further include means for preventing the vapor phase from exiting the device. In addition, the sample collection device of the invention includes an optional means for attaching to a centrifuge, e.g., holding the device in a centrifuge tube, or incorporating a feature functionally resembling a handle or a grip (FIG. 2-4), or, e.g., includes features such as a hook portion 63 to lock in mating features on a centrifuge, as shown in FIGS. 5 and 6.

In another aspect, the invention features a sample collection device having a receptacle body portion having a sample port, a sample chamber having an interior surface, a fluid conduit, positioned at least partially in the receptacle body, fluidly connecting the sample port with the sample chamber, and one or more fluid reservoirs in fluid communication with the sample chamber; and a vent port in atmospheric communication with the sample port. The reservoir can contain a fluid, such as dilution fluid or solute, or a fluid reagent, to be released from the reservoir and mixed with the sample within the device. Suitable reagents for introducing to the sample via the fluid reservoir can optionally include one or more of a stabilizing reagent, a detection reagent or detectable label, for example a reagent for detecting the presence or absence of an analyte in the sample. Alternatively, or in combination with providing a solute or reagent via a fluid reservoir, the device can include a dry reagent on at least a portion of the interior surface of the device, e.g., an interior surface of the sample chamber, which becomes solubilized upon contact with the liquid reagent, and/or by entry into the chamber of the resident fluid from the fluid reservoir, and is thereby introduced to the sample in suspended or soluble form.

The flow of fluid within the device is controlled by a combination of surface conditions, applied centrifugal forces, by applying pressure to particular regions of the housing of the device, e.g., to the cover of the receptacle body portion, and by holding the device at particular angles relative to gravitational forces. For example, fluid flow through the conduit portion of the device can be enhanced when the interior surface of the conduit is hydrophilic, for example, by applying a hydrophilic coating to all or a portion of the interior surface of the conduit. Capillary flow into the device can further be enhanced by including a vent port in the receptacle body portion of the device. Further capillary flow into the device can then be prevented allowing a vent plug, in operable alignment with the vent port, to block or expand and thereby close the vent port against further atmospheric or vapor exchange.

The receptacle body portion further includes a cavity in fluid communication with the sample chamber and centrifugally distal to the conduit.

In one aspect, the sample collection device of the invention collects and recovers a known, metered volume of a liquid sample. Preferably, the volume of sample collected is a function of the volume of the conduit, capillary, gutter, or channel through which the fluid enters the device. Flow of fluid into, within, and out of the device can be controlled by edging, or by various junctions, or gates, within the device. In one embodiment, a figurative ‘gate’, or ‘stop junction’, can be established by applying a hydrophobic coating, e.g., by applying a coating of a plastic material, to at least a portion of an interior surface of the device or by geometric relationship.

In another related aspect, the sample collection device of the invention can include, optionally, a sharp element for use when obtaining the sample, for example, to puncture the skin of the individual donating the sample, or to puncture a membrane or film of a container providing the fluid sample. The sharp element can be, without limitation, a needle cannula, the needle cannula having a bore, a sharpened tip, and a cut-out extending axially from the tip a chosen distance, the cut-out exposing the bore over at least a substantial portion of the chosen distance. Alternatively, the sharp element can be a barb, e.g., barb 52 (FIG. 5), e.g., a blade or wire barb.

In a related aspect, the invention features a method of handling a liquid sample, including the steps of providing any one of the sample collection devices disclosed herein, contacting a fluid sample with the device so as to allow the sample to enter the device, processing and/or storing the sample within the device, e.g., by one or more of the steps of diluting the sample, separating components out of the sample, and/or stably storing the sample, and then recovering the sample from the device in a volume and condition suitable for subsequent analysis. The invention is useful for collecting a fluid sample, without limitation as to the type of animal or the source of the biological fluid sample The method of the invention is suitable for use with samples in laboratory research, monitoring, and/or screening assays, and for diagnostic assays.

### BRIEF DESCRIPTION OF THE DRAWINGS

FIG. 1 is a flow diagram illustrating the functional elements of the sample collection device of the invention.

FIG. 2 is a perspective view of the sample collection device of the invention, showing cover 50 displaced and in mountable position over base 10.

FIG. 3 is a top interior view of one embodiment of the sample collection device of the invention.

FIG. 4 is a top interior view of an alternative embodiment of the sample collection device of the invention, the orifice of vent port 26 on an end of the device that is distal to conduit 20.

FIG. 5 is a perspective view (FIG. 5a) and top view (FIG. 5b) of an alternative embodiment of the collection device of the invention.

FIG. 6 is a schematic illustration of two collection devices installed in a centrifuge, where FIG. 6a is a top view illustration of the collection devices in spin position, and FIG. 6b is a side view schematic showing the two devices in stationary position (solid lines) and in spin position (dotted lines).

### DETAILED DESCRIPTION OF THE INVENTION

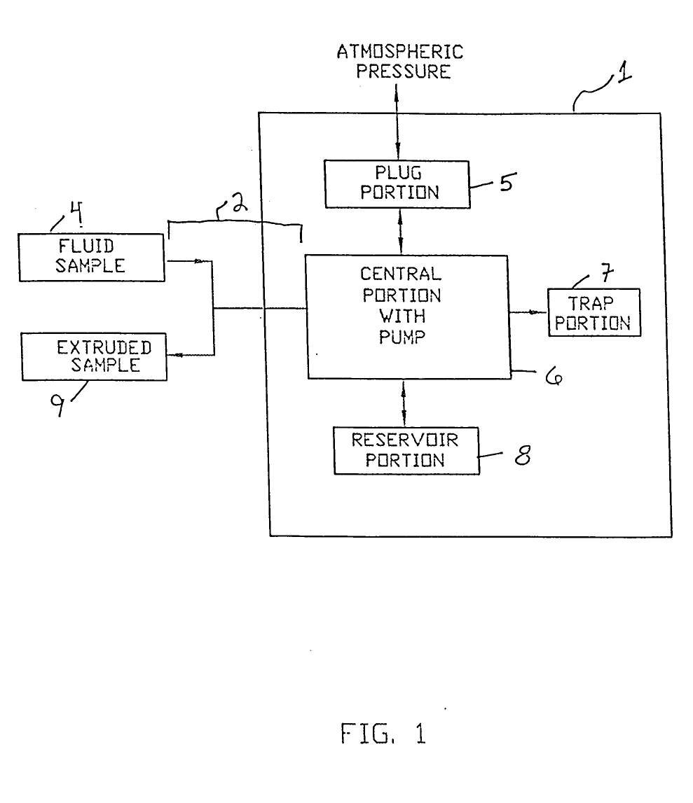

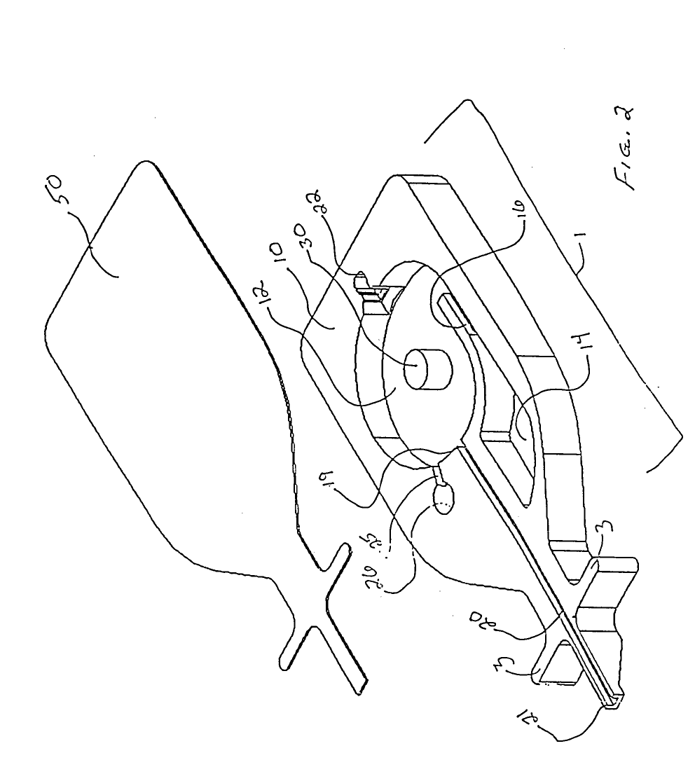

The sample collection device of the invention includes generally a receptacle body portion 1, a conduit portion 2, and optionally, an attachment portion 3. FIG. 1 is a flow diagram illustrating the functional portions of the sample collection device of the invention. Fluid sample is drawn into the central portion 6 of receptacle portion 1 through conduit portion 2. Generally, central portion 6 includes functionally a space for collecting and mixing the fluid sample 4, and for actuating a mechanism for expelling extruded sample fluid 9 from the device, again via conduit portion 2. Plug portion 5 ensures that central portion 6 is at atmospheric pressure when fluid sample is being collected and drawn into the device, and ensures that central portion 6 is sealed off from atmospheric contact when fluid is being extruded from the device. Trap portion 7 functions as a region for sequestering components that are separated from the fluid sample during centrifugation of the device. Reserved fluid portion 8 serves as a vehicle for storage and supply of a fluid intended to be mixed with sample within central portion 6.

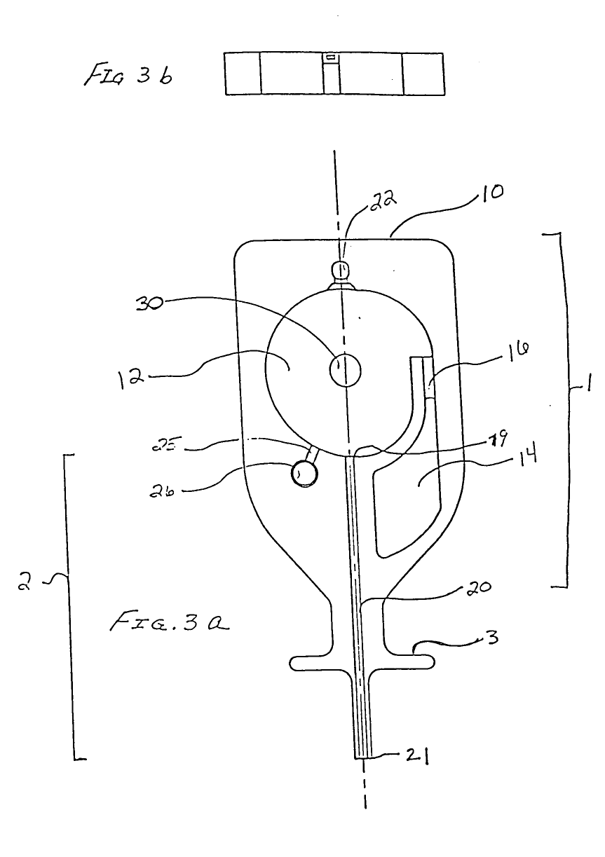

Referring to FIG. 2-5, cover 50 is shown in mountable position over base 10 (FIG. 2). When assembled, receptacle body portion 2 has a number of interconnected cavities and channels for passing and containing a fluid sample. In particular, receptacle body portion 1 has at least one sample chamber 12 for receiving and storing a fluid sample within the device. Without limitation as to methods of manufacture, sample chamber 12 can be formed as a portion of base 10; alternatively, sample chamber 12 is formed by the assembly of base 10 and cover 50, so that sample chamber 12 assumes its final form once cover 50 has been mounted and bonded to base 10.

Preferably, base 10 is a rigid plastic element, e.g., a thermoplastic or thermoset plastic, and can be prepared by methods known by those skilled in the art, e.g., without limitation, injection molding or blow molding.

The conduit portion 2 of the device extends outwardly from receptacle body portion 1. Conduit portion 2 includes conduit 20, outer conduit end 21, and inner conduit end 19. It is to be understood that the relative dimensions of conduit 20 are those that permit capillary force to move a small volume of fluid to flow from one end of the conduit to the other. After assembly, the shape of conduit 20 is preferably cylindrical, but can also be an elongated, hollow rod or ellipse; that is, an elongated hollow bore having a round, oval, square, or rectangular diameter. In particular, it is appreciated that capillary action can be enhanced by maximizing the interior surface area of conduit 20 relative to the volume of fluid sample, which favors rod or oval shaped channels. Nonetheless, the shape of conduit 20 should also take into account whether the biological constituents of the fluid sample, such as proteins, are vulnerable to denaturation and/or aggregate formation during passage. As aggregates are more likely to form in response to surface abrasion, and to collect in sharp corners. Thus, when collecting samples having an undesirable likelihood of aggregating, it is preferred that the interior surfaces of conduit 20 be rounded.

Conduit 20 can be an integral part of base 10, can be formed by the assembly of cover 50 to base 10, or can be inserted into the conduit portion of the sample collection device during use. Where the walls of conduit 20 are formed from the assembly of cover 50 to base 10, it is understood that the portion of conduit 20 within base 10 can have the shape of a gutter, for example, a unshaped gutter, having a rounded bottom that is part oval or spherical. Where conduit 20 is formed completely with base 10, conduit 20 can be, e.g., a cylindrically shaped passage.

The volume of sample fluid collected is determined, preferably, by the dimensions of conduit 20. Thus, for purposes of illustration, a device of the invention designed to collect sample sizes of about 25 μl could have a length of approximately 33.33 millimeter (mm), where the conduit 20 is a gutter of, e.g., 1 mm wide and 0.75 mm deep, or a cylinder with an inside diameter of about 1 mm and an outside diameter of about 1.5 mm. The volume of fluid held by conduit 20 is generally envisioned to be less than about 250 μl, 200 μl, or in the range of, e.g., 25-100 μl or greater than 10 μl and less than about 150 μl.

Outer conduit end 21 is an orifice or port open to the outside of the sample collection device, and serves as a sample port, or portal, for entry of fluid into the device. In an optional embodiment, outer conduit end 21 can be sufficiently sharp to use as a tool for pricking or puncturing skin, vein, or a membrane in order to draw and/or collect blood; in such cases, outer conduit end 21 is preferably glass or metal.

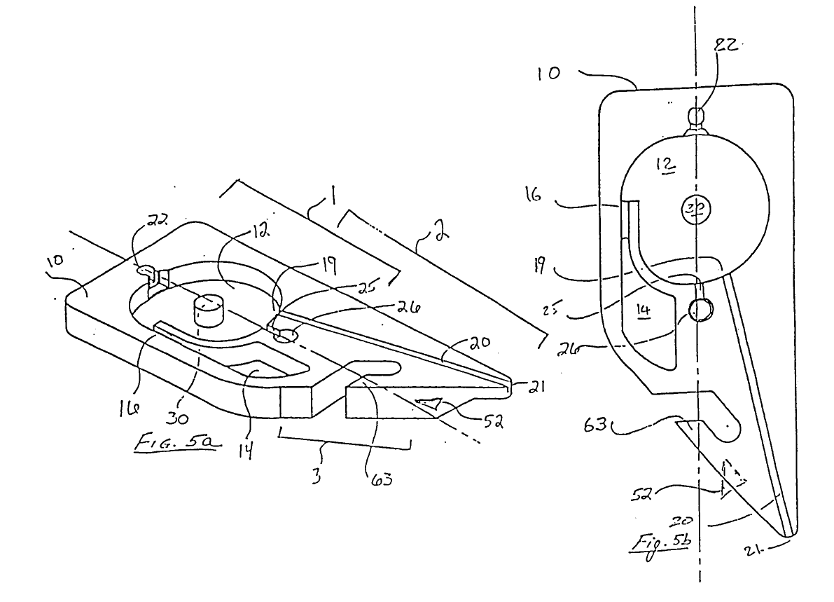

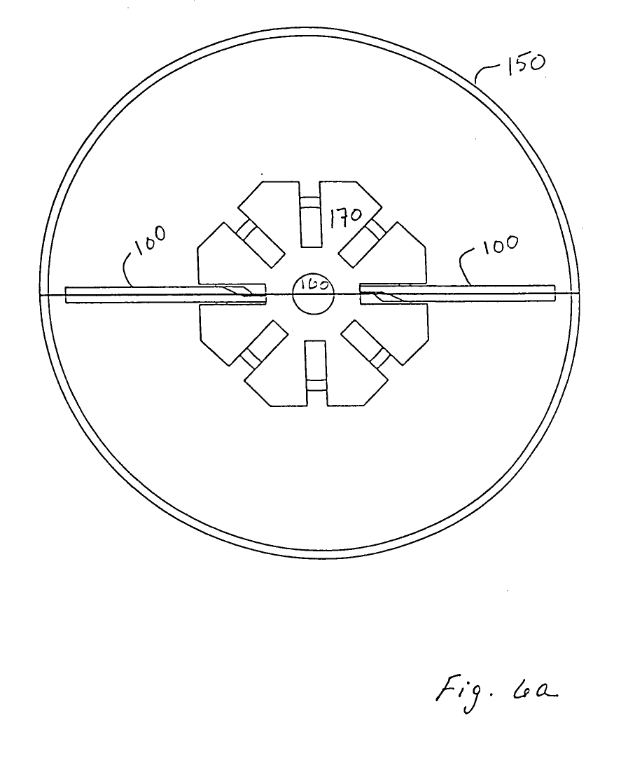

FIG. 5 illustrates an optional construction showing optional barb 52, which is intended to prick or cut into a surface, e.g., skin or vein in order to draw a drop of fluid sample, such as a drop of blood.

At the opposite end of conduit 20, inner conduit end 19 is the junction at which conduit 20 meets sample chamber 12, formed, e.g., by the intersection of the interior walls of conduit 20 with the walls of sample chamber 12. Inner conduit end 19 puts conduit 20 in fluid communication with sample chamber 12. In one optional embodiment, inner conduit end 19 is characterized by abrupt and/or sharp edges or corners, with the effect of terminating capillary flow.

In one optional embodiment of the invention the shape of attachment 3 as shown in FIG. 2-4 is configured to provide a region for attaching the device to processing machinery.

Capillary flow of fluid into receptacle body portion 1 through conduit 20 is favored by preparing base 10 using a material that is hydrophilic, known to those skilled in the art, such as, without limitation, glass, polyethylene tetraphtalate glycol (PETG), LEXAN® (General Electric Company Corporation, NY, N.Y.), or a form of polymethyl methacrylate (PMMA) such as, e.g., Plexiglas® (Rohm & Haas Company, Philadelphia, Pa.) or Lucite® (E. I. Du Pont De Nemours And Company, Wilmington, Del.).

At inner conduit end 19, conduit 20 terminates in the larger space of sample chamber 12, which causes capillary flow to decrease, preferably to cease, at that junction. Termination of flow at inner conduit end 19 can be further assured by adding, optionally, a hydrophobic coating to the device in the vicinity of inner conduit end 19, e.g., on the interior surface of the walls of conduit 20 proximal to inner conduit end 19, or on the interior surface of sample chamber 12 proximal to inner conduit end 19, or both. The hydrophobic coating impedes further flow of fluid into sample chamber 12. This in turn limits the volume of sample collected to the volume of conduit 20, thereby increasing the ability of the device to meter accurately the size of the sample. The vicinity of inner conduit end 19 can be rendered hydrophobic by applying a coating of hydrophobic material such as, without limitation, a plastic coating material or a coating of a stearic acid material. Additional suitable hydrophobic coatings are known to those skilled in the art; see, e.g., U.S. Pat. No. 5,912,134, hereby incorporated by reference in entirety. Another method is to make base 10, or a portion thereof, of hydrophobic material such as methacene catalyzed cyclic olephine (TOPAS®, Ticona GmbH, Frankfurt, Del.) and render conduit 20 hydrophilic by coating it with a hydrophilic substance such as PVA (polyvinyl alcohol) or heparin that is also non-thrombogenic.

Optionally, the inside of conduit 20 can be coated or treated with heparin or with an other agent known to those skilled in the art to delay blood clotting. Alternatively, base 10 may itself be made of a material that delays blood clotting.

Receptacle body 1 can further include one or more of a reservoir 14 as a reservoir for storing a fluid reagent, solute, or diluent (not shown). Reservoir 14 is in fluid communication with chamber 12 via reservoir channel 16. Reservoir channel 16 is preferably a narrow communication channel, akin to a similar capillary. The volume of reservoir 14 is determined by the desired volume of fluid reagent, solvent, or diluent to be added to the sample; for example, by way of illustration, reservoir 14 can contain about 75 μl of diluent. Preferably, channel 16 terminates at an edge of sample chamber 12, to prevent the mixture of fluid contained in sample chamber 12 from re-entering reservoir 14. The junction or intersection of channel 16 with chamber 12 can be rendered hydrophobic to create a stop junction or gate between reservoir channel 16 and chamber 12, by any of the methods and materials discussed in relation to creating stop junctions proximal to the region of inner conduit end 19, above. Alternatively, channel 16 may be in minimum bonded contact with cover 50 such that centrifugal forces on the fluid within reservoir 14 forces its way through channel 16.

It is self evident that reservoir 14 may be sized to hold the necessary volume of fluid and that the conduit may be sized as desired. Without limitation, a typical platelet count device requiring a 100 to 1 dilution may have a 20 μl capillary conduit and a reservoir of greater than 2 cc. or greater.

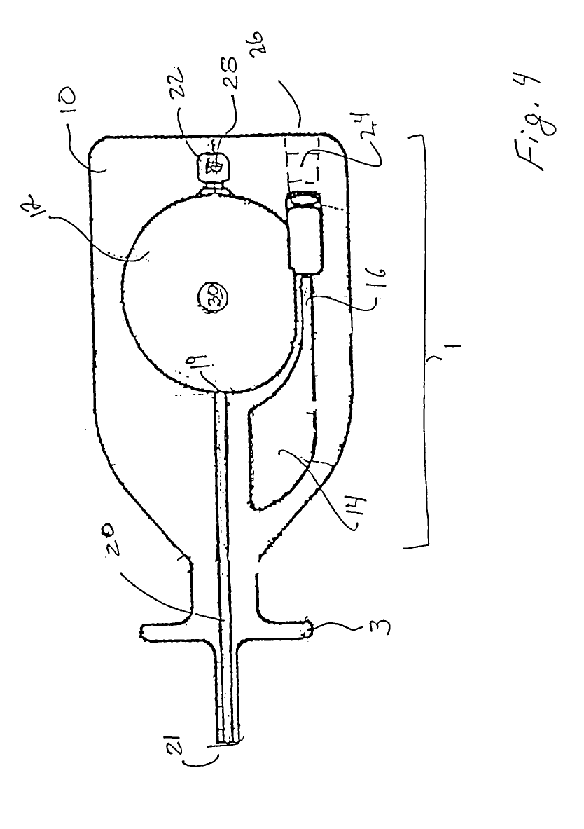

Base 10 further includes recess 22 in fluid communication with sample chamber 12. In one embodiment, recess 22 is formed as a recess in the walls of chamber 12. Recess 22 provides a region at which components of the sample collect when the sample collection device is centrifuged, in much the way that a pellet forms in the bottom of a centrifuge tube. For example and by way of illustration, red blood cells can be trapped within recess 22 following centrifugation. Preferably, recess 22 is diametrically opposed from that point on the device that would be closest to the central point of spin during centrifuging. For example, recess 22 can be located directly opposite from, and in line with, inner conduit end 19. Depending on the shape and degree of separateness of recess 22 from chamber 12, recess 22 can be a region of the wall of chamber 12, can be an indentation or aberration of the normal curve of the wall of chamber 12, or can be a cavity in communication with chamber 12. Preferably, recess 22 functions as a physical trap for sample components spun from the sample. ‘Trapping’ characteristics can be enhanced by, e.g., constricting the opening and/or channel between recess 22 and chamber 12. FIGS. 3 and 4 shows an embodiment of recess 22 having a necked region that retains trapped material and prevents its re-entry to chamber 12.

Optionally, a small volume of a gel barrier (‘barrier gel’; ‘separation gel’) can be placed in recess 22 to assist with the capture of components, such as red blood cells, to prevent lysis, and to prevent re-mixing of the spun components with the sample remaining in chamber 12. The barrier gel is an inert barrier material which has a density between that of cells and plasma. Suitable materials for use as a gel barrier are known to those skilled in the art, including, without limitation, thixotropic polyester gel separator, and polyethylene glycol (Cole-Parmer, Vernon Hills, Ill., 60061). (See, also, U.S. Pat. No. 5,257,984, issued Nov. 2, 1993, and U.S. Pat. No. 3,852,194, each hereby incorporated by reference in entirety). During centrifugation, the inert barrier gel rises to the plasma/cell interface where it lodges and forms a physical barrier between the liquid portion and the cells. This inhibits re-mixing of the spun components with the fluid sample. Gel barrier materials can be optionally treated with an anticoagulant, for example, heparin or EDTA, before use. Other materials for and methods of enhancing separation are known to those skilled in the art, e.g., U.S. Pat. No. 4,189,382, issued Feb. 19, 1980, hereby incorporated by reference in entirety.

Because surface tension forces are relatively weak, the flow of fluid into conduit 20 can be enhanced by equipping the device with a mechanism for pressure equilibrium, such as by providing an air permeable vent in receptacle body 1, distal to outer conduit end 21, so that both ends of the capillary are directly or indirectly open to atmospheric pressure. After fluid has entered the device, it then becomes necessary to obstruct the vent so that the fluid can be expelled.

In order for fluid to both enter and exit the device in an efficient manner, receptacle body 1 can further include vent port 26, which is a closeable air vent. Vent port 26 is preferably an enclosed conduit, such as a cylindrically shaped channel, for the passage of air. Vent port 26 can be filled with an air porous material to form vent plug 24. Suitable materials for use as vent plug 24 include a thermoplastic material, polyethylene, polypropylene, polytetrafluoroethylene (PTFE; e.g., GORE-TEX®, W.L. Gore & Associates, Inc., Newark Del.), e.g., porous plastic (e.g., porous plastic marketed by M.A. Industries (Peachtree City, Ga.), thermoplastics, e.g., supplied by Trexel, Inc. (Woburn, Mass.), or POREX® (Porex Technologies Corporation, Fairburn, Ga.). Although porous when dry, such materials are designed to become fully closed when wet. (See, U.S. Pat. No. 5,916,814, issued Jun. 29, 1999, hereby incorporated by reference in entirety). The porous region is intended to permit air to traverse so insure equal air pressure at both ends of the capillary and therefore uninhibited blood aspiration. When the vent is wet it is closed and the diluted serum can be forced out by pressing the cover/membrane. A central deflection of 0.1 mm should force out about 50 micro-liter.

Vent plug 24 is located such that, when the collection device is tilted on an angle so as to expel fluid, the fluid wets vent plug 24. Preferably, vent port 26 is proximal to, or connected to, inner conduit end 19. In the illustrative embodiment depicted in FIGS. 1-3, the vent plug 24 can absorb 1 to 20 μl, depending upon the dimensions and size of the plug. Where precise concentrations of components or dilution ratios are required, it may also be necessary to add an equal amount of solution, e.g., dilution fluid, to reservoir 14, to compensate for fluid absorbed by the vent plug, thereby achieving the desired final concentrations.

Preferably, vent plug 24 is located in a vent port 26 that is cylindrically tapered, having its larger opening on the same side, and adjacent and connected to, sample chamber 12, via vent channel 25. Generally, vent channel 25 provides access from chamber 12 to vent port 26, e.g., by acting as a passageway. Preferably, vent plug 24 can be recessed below the surface of receptacle body 1 to permit fluid to enter and cover its entire surface. Vent plug 24 absorbs fluid and becomes impermeable to air. In some situations, such as during storage, when it is desirable to prevent vapor transfer, the outside of vent port 26 can be further sealed with a tape (not shown). Optionally, the tape can form part of a labeling system, that can then be detached and relocated for identifying the source of the fluid sample. (See, U.S. Pat. No. 4,884,827, issued Dec. 5, 1989, hereby incorporated by reference in entirety.)

In the alternative construction illustrated in FIG. 4, vent port 26 is shown to be approximately in line with the exit 16 of the reservoir 14.

Vent plug 24 can be replaced with a membrane with similar properties such as available from the W.L. Gore and Associates, Inc. of Newark, Del.

Cover 50 is mountable and sealable to base 10, typically by using adhesive, heat, or ultrasonic welding techniques. Cover 50 forms a roof, cover, or top over base 10 to form receptacle body 1. Preferably, cover 50 is prepared from a material that can flex or deform in response to applied pressure. In one embodiment, cover 50 is a membrane or a film, for example a bonded resilient plastic film. Where it is desired that the user of the sample collection device be able to view the interior contents of the device, cover 50 can be fully or partially transparent. Cover 50 is bonded to the top flat surface of base 10, enclosing the contents of one or more of the chambers, channels, and cavities within receptacle body 1. Although illustrated in FIG. 2 as fully covering base 10, cover 50 need not extend to the tip of the conduit 20.

In the center of sample chamber 12 is post 30, which is sized to limit the possible displacement of cover 50 in a controlled manner. When the device is positioned to be approximately vertical pointing down, fluid can be forced out of the device through conduit 20. This is done by exerting pressure on cover 50, e.g., by pressing a finger against cover 50, depressing cover 50 until it makes contact with post 30. The degree to which cover 50 is free to travel predetermines the volume of fluid expelled from the device. The free travel of cover 50 further permits conduit 20 to refill with fluid. Repeating the action permits a metering of the volume exhausted.

In one embodiment, cover 50 can be made from a composite film of multiple layers, one layer being a layer of elastic material, a second layer being non-porous, and a third layer that is bondable to base 10, e.g., by heat or friction. In one option, cover 50 is prepared from a transparent material, so as to enable the contents of the device to be viewed through cover 50.

Assuming that the shape of the deflected cover 50 is that of a segment of a sphere, the displaced volume V can be derived from:
V=0.167πh(0.75d²+h²)

Assuming that d=16 mm, that the capillary has a volume of 25 μl, and expecting that 50 μl will be the desired recovery volume, V=75 μl clearance, and h needs to he approximately 0.75 mm. The volume displaced by the deflection of the membrane cover equates the sum of the volume of conduit 20 and the desired useable volume of fluid. Retracting the membrane to its original position empties the conduit and permits air to re-enter sample chamber 12.

Information Tracking. The sample collection device can be equipped with an optional means of recording or displaying information about the sample, such as a tag, a bar code, or a surface area suitable for writing or applying markings. The recorded or displayed information can be any information desired for performing or tracking the sample and/or the diagnostic assay for which the sample is intended. Suitable information can include, without limitation, the date, the animal number, condition of storage of the sample within the tool, or processing conditions during sample handling, and any additional information necessary. In another option, additional tags or bar coded labels can to provided with the tool for recording corresponding information; the second tags or labels can then be removed from the tool to be, e.g., attached to a patient record or to an animal's cage, or to be included with the diagnostic assay, as desired. By way of example, double labels, each having identification and serialized numbers or codes, are affixed to the sample collection device, so that one is permanently attached to the sample collection device, and the other is removable and capable of being subsequently attached or bonded elsewhere, as described above, or scanned or otherwise recorded in another informational storage medium. The information on the second identifier can then be used to correlate with the original sample if needed at a later date.

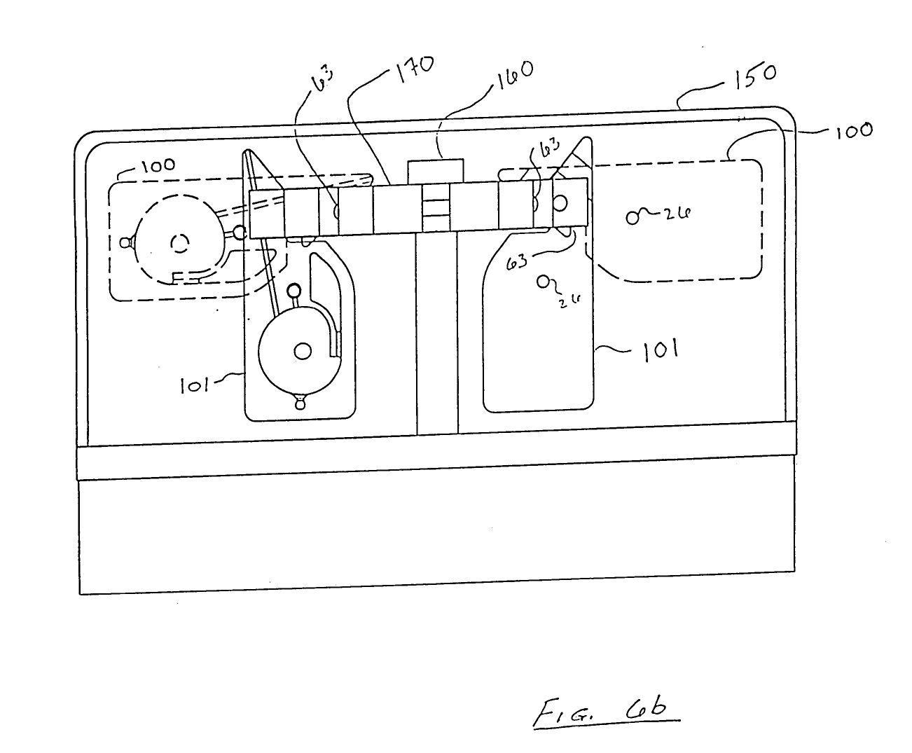

Mode Of Operation. For illustrative purposes, collection of a blood sample will be described. First a drop of blood is contacted with the conduit of the device and a predetermined volume of fluid enters the conduit. Optionally, the drop of blood can be formed in response to puncturing skin or a membrane with a sharp portion of the device, e.g., where outer conduit end 21 is sharp, or where the device is equipped with a barb 52 or a blade or lancet. The device, containing the fluid sample, is then positioned within a centrifuge so that recess 22 is at the furthest distance from the axis of the centrifuge. This can be accomplished by placing the device inside a centrifuge tube. Alternatively, the receptacle body can further include one or more sites, e.g., protrusion 3 of FIG. 2-4, to mate with an appropriately modified centrifuge platen. (See, for example, U.S. Pat. No. 5,326,398, issued Jul. 5, 1994, U.S. Pat. No. 5,480,484, issued Jan. 2, 1996, and U.S. Pat. No. 5,912,134, issued Jun. 15, 1999, each of which are hereby incorporated by reference in entirety.) In the alternative embodiment shown in FIGS. 5 and 6, the device is equipped with hook 63, which can be attached to the rotor of centrifuge 150. In FIG. 6, centrifuge rotor 170 is placed on shaft 160 of centrifuge 150. Hook 63 of sample collection device 101 is attached to centrifuge rotor 170. When the rotor 170 is spun, the sample collection device 100 (shown in dotted lines) is spun so that maximum gravitational force is exerted on the end of the device 100 that includes recess 22.

During centrifugation, the fluid sample is spun out of conduit 20 into sample chamber 12. Certain components of the sample, e.g., red blood cells, are spun into recess 22. The red blood cells separate and aggregate in the region of recess 22, where they are likely to clot. Where the cavity of recess 22 has a narrow entrance region, once the red blood cells form a solid clot they are retained within recess 22. Where the device includes an optional gel barrier within recess 22, the red blood cells can be captured by the gel barrier within recess 22.

A further effect of the centrifugal force is to cause fluid in reservoir 14 to be released from reservoir 14. The solution enters sample chamber 12 to be mixed, and thereby dilute, the fluid sample therein. In the embodiment of FIG. 4, a predetermined portion of the fluid sample and reservoir fluid, e.g., a diluent, released into sample chamber 12 is absorbed by vent plug 24, causing vent plug 24 to swell and close the device. Vent plug 26 is typically cylindrical and forced into tapered cavity 24 where it is held by friction.

If desired, reservoir channel 16 and its surface properties may be such that either the blood sample or the diluent are put in motion at different speeds of rotation. Also, channel 16 may be blocked to prevent fluid transfer as well as vapor transfer. Such blockage would need to be terminated upon usage of the device. Blockage may be terminated by centrifugation. Such blockage may be in the form of a limited adhesion of cover 50 to a narrow segment blocking the end of exit channel 16, or it may be due to an inserted element that would be displaced by centrifugal force. Such element may be a high density element such as a stainless steel or ceramic ball or a plastic flap that would be displaced to open the channel. Such blockage can also be due to the use of stop junctions. (See, U.S. Pat. No. 5,912,134, incorporated by reference above.)

An alternate construction is to hold the fluid within a blister pack, which is in turn placed in reservoir 14. The material of the blister pack would be selected to burst under the centrifugal force, or to rip against a sharp feature at the outlet of reservoir 14 or reservoir channel 16.

In order to expel suitably diluted serum, the sample collection device should be held approximately vertically so that the mixed diluted serum within sample chamber 12 locates at inner conduit end 19, enters and swells the vent plug 24 in the embodiment of FIGS. 2, 3, and 5, causing the vent plug 24 to block vent port 26. The sample collection device is then ready to expel a preset volume of diluted fluid through conduit 20 by pressing and deforming cover 50. Pressing a finger against cover 50 until it contacts post 30 pushes out a volume of fluid determined by the dimension of sample chamber 12 and the free travel of the membranous cover 50. Lifting the finger permits the membrane cover to regain its original position. Residue fluid in conduit 20 voids into sample chamber 12 permitting air to enter. Care should be taken to avoid aspiring any fluid back into the device beyond the content of the conduit. Repeating the action permits multiple metering of the volume exhausted.

The fluid within reservoir 14 can be inserted into reservoir 14 prior to bonding cover 50 to base 10, or can be injected into reservoir 14 by piercing cover 50 after it has been installed and then re-sealing the cover with a bonding agent such as tape. An alternative method of placing dilution fluid into reservoir 14 can be used in devices in which vent port 26 is aligned with reservoir channel 16 (FIG. 4), by placing dilution fluid into reservoir 14 with the use of a syringe prior to installing vent plug 26.

It may also be desirable to close the outer conduit end 21 of conduit 20 to prevent vapor transit. Numerous techniques known to those skilled in the art are available for this purpose, for example, stoppers or a weakened plastic end to be torn off to initiate usage. Sealing clays and waxes are widely available and known to those skilled in the art. Caps for use with capillary tubes are also available (Fisher Scientific Company, Hampton, N.H.).

1. A sample collection device comprising:
a) a receptacle body portion having a sample port;
b) a sample chamber having an interior surface;
c) a fluid conduit, positioned at least partially in said receptacle body, fluidly connecting the sample port with the sample chamber; and
d) a fluid reservoir in fluid communication with said sample chamber; and
e) a vent port in atmospheric communication with said sample port.

2. The device of claim 1, wherein said device further comprises a vent plug in operable alignment with said vent port.

3. The device of claim 1, wherein said device further comprises means for attaching said receptacle body to a centrifuge.

4. The device of claim 1, wherein said receptacle body portion further comprises a cavity in fluid communication with said sample chamber and centrifugally distal to said conduit.

5. The device of claim 1, further comprising a solute in said fluid reservoir.

6. The device of claim 5, wherein said solute is a dilution fluid.

7. The device of claim 5, wherein said solute further comprises a stabilizing reagent.

8. The device of claim 5, wherein said solute further comprises an analyte detection reagent.

9. The device of claim 1, wherein said device comprises a plurality of fluid reservoirs.

10. The device of claim 1, wherein said device further comprises a dry reagent on at least a portion of said interior surface of said sample chamber.

11. The device of claim 1, wherein said fluid conduit has a volume, and sample collection device has a sample collection capacity approximately equivalent to said fluid conduit volume.

12. The device of claim 1, wherein said sample chamber has an interior surface, at least a portion of said interior surface being hydrophobic.

13. The device of claim 1, wherein said fluid conduit comprises an interior surface characterized as being hydrophilic.

14. A sample collection device comprising a conduit portion and a receptacle body portion in fluid communication with said conduit portion, said conduit portion having a volume of less than 200 microliters, and said receptacle body portion comprising, affixed to said receptacle body portion:
a) means for allowing a fluid sample to enter said receptacle portion via said conduit portion; and
b) means for forcing said fluid sample to exit said receptacle portion via said conduit portion.

15. The sample collection device of claim 14, further comprising a means for attaching said device to a centrifuge.

16. The sample collection device of claim 14, wherein said receptacle body portion further comprises a fluid reservoir, a resident fluid within said fluid reservoir, and means for allowing said resident fluid to mix with said fluid sample.

17. The sample collection device of claim 14, wherein said receptacle body portion further comprises a means for sequestering a separable component from said fluid sample.

18. The sample collection device of claim 14, wherein said receptacle body portion comprises an interior space having an interior pressure, and further comprises a means for maintaining said interior pressure at atmospheric pressure.

19. The sample collection device of claim 18, wherein said receptacle body further comprises means for increasing and decreasing said interior pressure.

20. The sample collection device of claim 18, wherein said receptacle body portion further comprises means for maintaining said interior pressure at atmospheric pressure.

21. The sample collection device of claim 18, wherein said fluid sample has a vapor phase, and wherein said receptacle body further comprises means for preventing said vapor phase from exiting said device.

22. A method for collecting and recovering a liquid sample, said method comprising the steps of:
a) contacting a liquid sample with the sample collection device of claim 14 so as to allow a known volume of said sample to enter said receptacle body portion of said device;
b) subjecting said sample collection device to centrifugal force; and
c) applying pressure to said receptacle body portion of said device, so as to extrude said sample from said device.
